(19) United States
(12) Patent Application Publication
(10) Pub. No.: US 2018/0272189 A1
(43) Pub. Date: Sep. 27, 2018

(54) APPARATUS AND METHOD FOR BREATHING AND CORE MUSCLE TRAINING

(71) Applicant: Fangwei Lee, San Carlos, CA (US)

(72) Inventor: Fangwei Lee, San Carlos, CA (US)

(21) Appl. No.: 15/467,137

(22) Filed: Mar. 23, 2017

(51) Int. Cl. A63B 24/00; G06F 3/01; G09B 19/00; A63B 23/18

(52) U.S. Cl. CPC A63B 24/0075; G06F 3/011; A63B 24/0062; G09B 19/003; A63B 2220/70; A63B 2220/803; A63B 2220/40; A63B 2230/00; A63B 23/18

(57) ABSTRACT

Systems and methods for breathing and core muscle training with sensors and multi-sensory output are disclosed. A particular embodiment includes: an input unit including a plurality of sensors; an output unit including a plurality of multi-sensory output devices; and a processing unit, in data communication with the input unit and the output unit, the processing unit being configured to: determine a prompted movement of a training program and use the output unit to prompt the user to perform the prompted movement; receive sensor data from the input unit, the sensor data corresponding to the user's physical movements and biomedical condition; configure the output unit to render a simulation of the user's physical movements in a virtual environment; score the user's physical movements relative to the prompted movement; and determine a next prompted movement of the training program and use the output unit to prompt the user to perform the next prompted movement until the training program is complete.

### BACKGROUND

### Technical Field

The present disclosure generally relates to biomedical devices, exercise devices, physical therapy devices, and virtual reality systems and methods. More specifically, the present disclosure relates to apparatus and methods for breathing and core muscle training with sensors and multi-sensory output.

### Related Art

Most breathing techniques, core exercises, physical training, and relaxation techniques require a good understanding of a user's own body and a good understanding of the related energy and physiological processes (depending on the therapy). It can be difficult for some users to perform these techniques correctly without a human instructor. Even with a human instructor, the user may not receive consistent training across different instructors as each instructor has a different teaching style.

Meanwhile, with the proliferation in consumer electronics, there has been a renewed focus on wearable technology, which encompasses innovations such as wearable computers or devices incorporating either augmented reality (AR) or virtual reality (VR) technologies. Both AR and VR technologies involve computer-generated environments that provide entirely new ways for consumers to interact with computing or electronic devices and virtual environments. In augmented reality, a computer-generated environment is superimposed over the real world (for example, in Google Glass™). Conversely, in virtual reality, the user is immersed in the computer-generated virtual environment (for example, via a virtual reality headset such as the Oculus Rift™)

### SUMMARY

The various embodiments described herein offer a solution to the problems identified above by providing an apparatus and method to perform, monitor, and manage the physical training of a user with computerized procedures and connected input/output and control devices. The various embodiments described herein provide an apparatus and method to perform breath training and (body) core muscle training with a control device having one or more input sensors (e.g., trackers, inertial measurement unit (IMU), biosensors, etc.) and multi-sensory output (e.g. visual, audio, haptics). In an example embodiment, a VR or AR headset is used to provide an immersive virtual environment for the user to facilitate the user's physical training.

The apparatus and methods of example embodiments can be used for breathing training, core exercise training, physical training, relaxation techniques, and for various kinds of therapies including, but not limited to:

i. Yoga—breathing and core body muscle training for various kind of Yoga.

ii. Mindfulness—breathing techniques for mindfulness. Assist the users to enter a mindful state more easily.

iii. Physical/occupational therapy—breathing or core muscle training for specific tasks or occupations.

iv. Meditation—breathing training to assist the user to enter the state of meditation or relaxation more easily.

v. Rehabilitation (e.g., drug/alcohol or other substance dependency)—reduce craving and calm the emotion state using breath training.

vi. Rehabilitation (e.g., disability or injury recovery)—core muscle training for specific disabilities or breath training to calm the emotional state.

vii. Desensitization (e.g., psychology)—breath training for relaxation for various kinds of desensitization (e.g., systematic desensitization) viii. Relaxation—breathing training to release stress in user's body.

ix. Military Training (e.g., tactical breathing)—train tactical breathing or combat breathing techniques to reduce stress.

The apparatus and methods of example embodiments can also be used in various kinds of breathing and body core training. For example, example embodiments can be used for a variety of techniques including, but not limited to:

i. Square breathing

ii. Tactical breathing

iii. 4-7-8 breathing

iv. Mindfulness breathing used in Dialectical Behavioral Therapy (DBT)

v. Abdominal Breathing

vi. Progressive Relaxation

vii. Body core strength and balancing

Other aspects and advantages of the example embodiments will become apparent from the following detailed description taken in conjunction with the accompanying drawings which illustrate, by way of example, the principles of the example embodiments.

### BRIEF DESCRIPTION OF THE DRAWINGS

For a better understanding of the example embodiments, reference should be made to the following detailed description taken in conjunction with the accompanying drawings, in which:

FIG. 1 illustrates a block diagram of an example control system consistent with the example embodiments;

FIGS. 2 through 4 illustrate example embodiments of a user wearable system including a headset and a computing or control unit, wherein the control unit can be integrated within the headset or separately housed;

FIG. 5 is a processing flow chart illustrating an example embodiment of a method as described herein;

FIGS. 6 and 7 illustrate an example embodiment of a user wearable system wherein sensor inputs are used to estimate a user's breathing status;

FIGS. 8 and 9 illustrate an example embodiment of a user wearable system wherein sensor inputs are used to monitor and direct user hand movements for full-body muscle training;

FIG. 10 illustrates an example embodiment of a method for training a user in optimal breathing performance by displaying two pointing targets to focus the user's gaze during inhale and exhale breathing cycles;

FIG. 11 illustrates an example embodiment of a method for training a user in optimal breathing performance by displaying more than two pointing targets to focus the user's gaze during a square breathing exercise;

FIG. 12 illustrates an example embodiment of a method for training a user in optimal breathing performance by providing two height planes to focus the user's gaze at a desired height during inhale and exhale breathing cycles;

FIG. 13 illustrates an example embodiment of a method for training a user in optimal breathing performance by monitoring the height of a user's gaze over time to determine corresponding inhale and exhale breathing cycles;

FIG. 14 is a processing flow chart illustrating an example embodiment of a method as described herein; and

FIG. 15 shows a diagrammatic representation of a machine in the example form of a mobile computing and/or communication system within which a set of instructions when executed and/or processing logic when activated may cause the machine to perform any one or more of the methodologies described and/or claimed herein.

### DETAILED DESCRIPTION

Reference will now be made in detail to the example embodiments illustrated in the accompanying drawings. Wherever possible, the same reference numbers will be used throughout the drawings to refer to the same or like parts.

Apparatus and methods disclosed herein in various example embodiments address the above described needs. For example, apparatus and methods disclosed herein can provide and facilitate breathing and core muscle training with sensors and multi-sensory output. The disclosed apparatus and methods can be implemented on low power mobile devices and/or three-dimensional (3D) display devices. The apparatus and methods can also enable real-life avatar control. The virtual world may include a visual environment provided to the user, and may be based on either augmented reality or virtual reality.

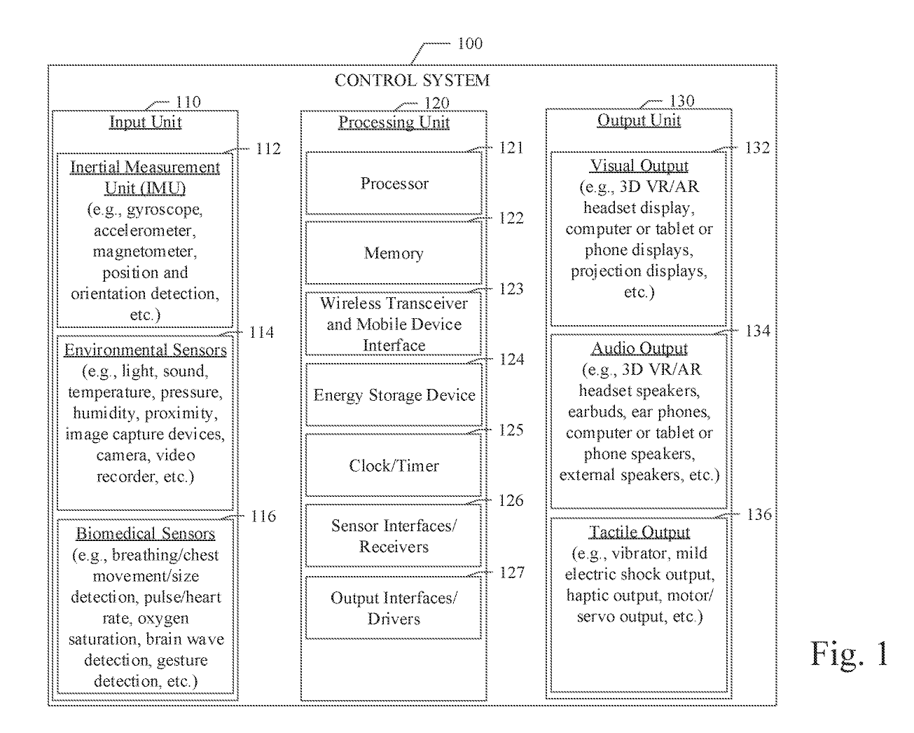

FIG. 1 illustrates a block diagram of an example control system 100 consistent with the example embodiments. As shown in FIG. 1, control system 100 may include an input unit 110, a processing or computing unit 120, and an output unit 130. The input unit 110 can include an array of motion, movement, and orientation sensing and tracking devices including inertial measurement unit (IMU) sensors and trackers 112, environmental sensors 114, and biomedical sensors 116. In an example embodiment, IMU sensors 112 can include one or more of a gyroscope, accelerometer, magnetometer, global positioning system (GPS) receiver, position and orientation detection trackers, and the like. The environmental sensors 114 can include an array of environmental sensing devices for measuring one or more of a variety of environmental conditions including light, sound, temperature, pressure, humidity, proximity, and the like. The environmental sensors 114 can also include image capture devices, cameras, video recorders, and the like. The biomedical sensors 116 can include an array of biological sensing devices for measuring one or more of a variety of biomedical conditions of a user including breathing/chest movement/size detection, pulse/heart rate, oxygen saturation, brain wave detection, gesture detection, galvanic skin response (GSR), and the like. It will be apparent to those of ordinary skill in the art in view of the disclosure herein that the various sensing and tracking devices of the input unit 110 are separately available in the art.

In an example embodiment, the processing unit 120 can include one or more of a data processor or central processing unit (CPU) 121, a data storage device or memory 122, a wireless data transmitter and receiver (transceiver) 123, which may include an interface for a standard mobile device, such an a smartphone. The processing unit 120 can further include one or more of a clock or timer 125, a set of interfaces or receivers for the various sensors of the input unit 110, and a set of interfaces or drivers for the various output devices of the output unit 130. It will be apparent to those of ordinary skill in the art in view of the disclosure herein that the various data processing and control devices of the processing unit 120 are separately available in the art.

The control system 100, and the processing unit 120 integrated therein, can be operatively connected to a network or any type of communication link that allows the transfer of data from one component to another via the wireless transceiver 123. The network may include Local Area Networks (LANs), Wide Area Networks (WANs), Bluetooth™, and/or Near Field Communication (NFC) technologies, and may be wireless, wired, or a combination thereof. Memory 122 can be any type of storage medium capable of storing binary data, processing instructions, audio data, and imaging data, such as video or still images. The video or still images may be displayed in a virtual world rendered via the output unit 130.

In an example embodiment, the output unit 130 can include one or more of a visual output unit 132, an audio output unit 134, and a tactile output unit 136. In the example embodiment, the visual output unit 132 can include one or more of a 3D VR/AR headset display, a computer display, a tablet display, a mobile device or smartphone display, a projection display, and the like. Visual output unit 132 can further include various types of other display devices such as, for example, a display panel, monitor, television, projector, or any other display device. In some embodiments, visual output unit 132 can include, for example, a display or image rendering device on a cell phone or smartphone, personal digital assistant (PDA), computer, laptop, desktop, a tablet PC, media content player, set-top box, television set including a broadcast tuner, video game station/system, or any electronic device capable of accessing a data network and/or receiving imaging data. In the example embodiment, the audio output unit 134 can include one or more of a set of 3D VR/AR headset speakers, earbuds, ear phones, computer speakers, tablet speakers, mobile device or smartphone speakers, external speakers, and the like. In the example embodiment, the tactile output unit 136 can include one or more of a vibrator, mild electric shock device, haptic output device, motor/servo output, and the like. The various output devices of the output unit 130 of an example embodiment provide a multi-sensory output device for the control device 100. It will be apparent to those of ordinary skill in the art in view of the disclosure herein that the various output devices of the output unit 130 are separately available in the art.

It will also be apparent to those of ordinary skill in the art in view of the disclosure herein that the control system 100 can be implemented in whole or in part in a standard computing or communication device, such as a computer, a laptop, a tablet personal computer (PC), a cell phone or smartphone, a personal digital assistant (PDA), a media content player, a video game station/system, or any electronic device capable of capturing data, processing data and generating processed information, and rendering related output. In the example embodiments described herein, processing logic can be implemented as a software program executed by a processor and/or as hardware that converts analog data to an action in a virtual world based on physical input from a user. The action in the virtual world can be depicted in one of video frames or still images in a 2D or 3D format, can be real-life and/or animated, can be in color, black/white, or grayscale, and can be in any color space.

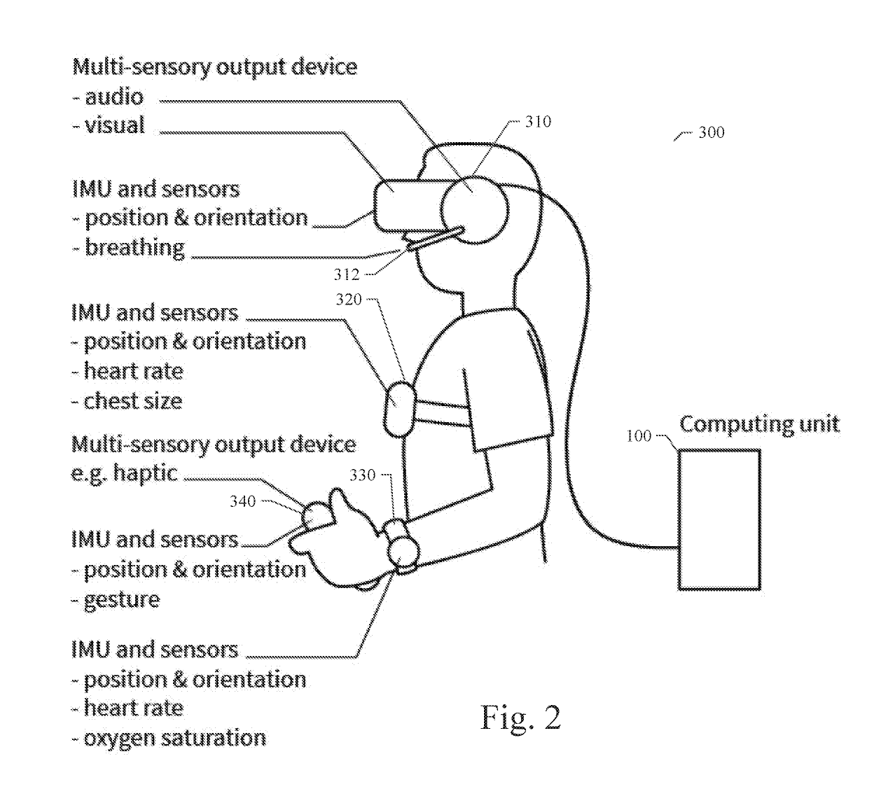

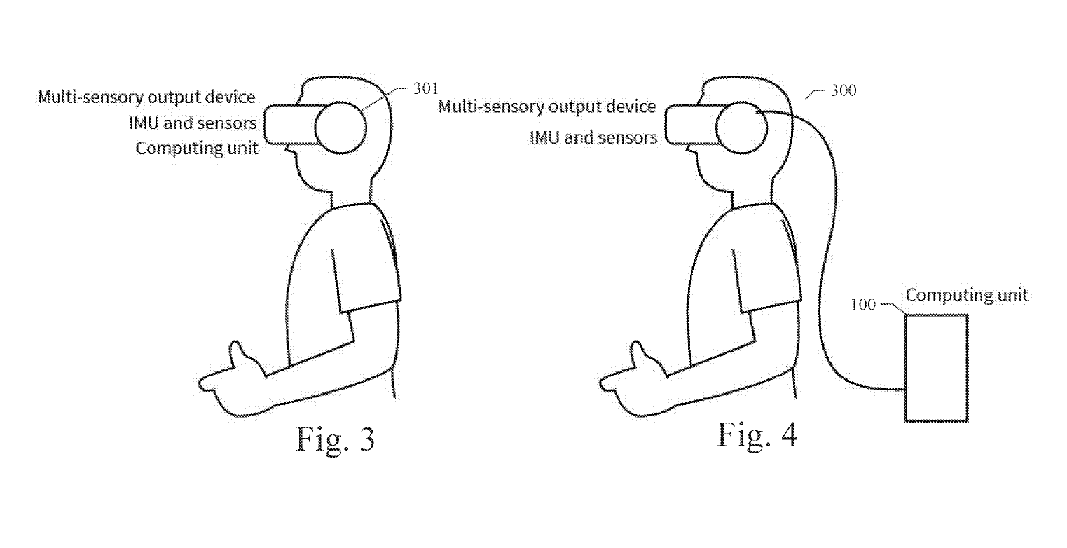

FIGS. 2 through 4 illustrate example embodiments of a user wearable system 300 including a headset 310 and the computing or control unit 100, wherein the control unit 100 can be integrated within the headset 310 or separately housed. The headset 310 can be, for example, a virtual reality headset, a head mounted device (HIVID), a cell phone or smartphone, a personal digital assistant (PDA), a computer, a laptop, a tablet personal computer (PC), a media content player, a video game station/system, or any electronic device capable of providing or rendering imaging data. The headset 310 may include software applications that allow headset 310 to communicate with and receive imaging data from the control unit 100, or a network or local storage medium. As described above, the user wearable system 300 can receive data from a network source via the wireless transceiver 123. In example embodiments as shown in FIG. 2, various components of the user wearable system 300 can be separately housed. For example as shown in FIG. 2, the headset 310 can include audio and visual output devices of the output unit 130. The headset 310 can also include the breathing or breath sensor 312 of the input unit 110. Various other sensors of the input unit 110, such as position/orientation sensors, heart rate sensors, breathing sensors, and chest size/movement sensors can be installed in a chest mounted device 320. Various other sensors of the input unit 110, such as position/orientation sensors, heart rate sensors, and oxygen sensors can be installed in a wrist-mounted device 330. Vibration or haptic devices of the output unit 130 can be installed in a hand-held device 340. Various other sensors of the input unit 110, such as position/orientation sensors and gesture detection sensors can also be installed in the hand-held device 340. It will be apparent to those of ordinary skill in the art in view of the disclosure herein that the input, control, and output devices of various embodiments can be integrated together or separately housed as needed for particular applications of the technology disclosed herein.

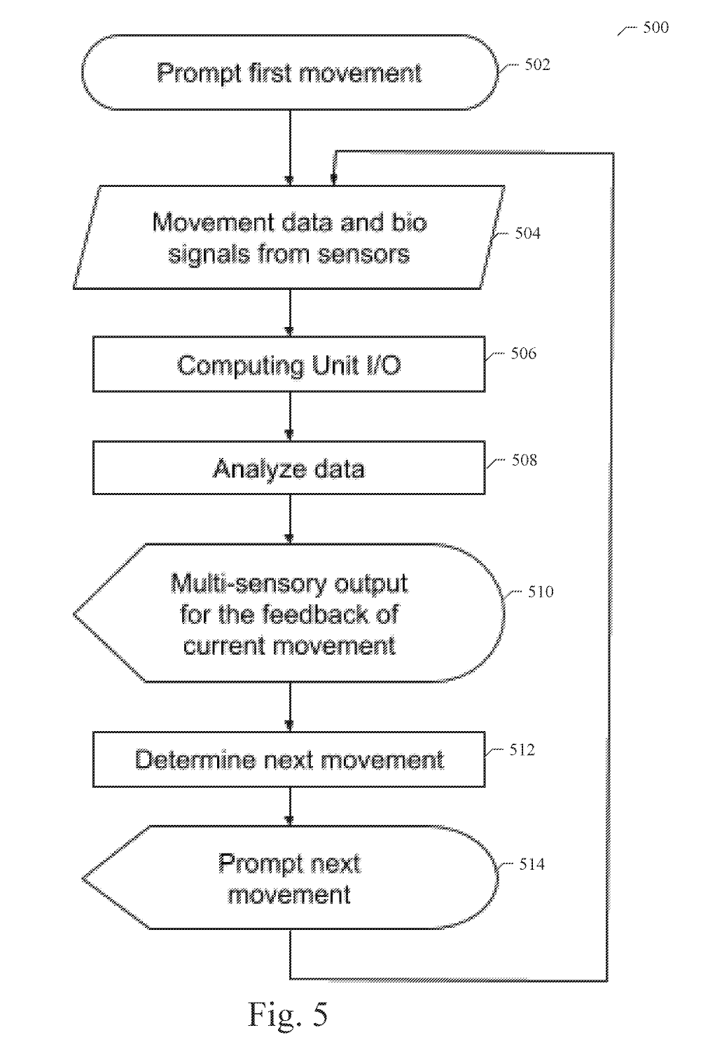

FIG. 5 is a processing flow chart illustrating an example embodiment of a method 500 as described herein. The method 500 of the example embodiment includes the following process operations:
The control unit 100 determines the first movement and prompts the user via the multi-sensory output devices of the output unit 130 (process operation 502).
The trackers and sensors of the input unit 110 capture the user's physical muscle movement and biomedical signals (process operation 504).
The raw data signals received from the input unit 110 are provided to the control unit 100 (process operation 506).
The control unit 100 analyzes the raw data signals and converts the data into indicators for scoring and performance tracking (process operation 508).
Based on the indicators generated by the control unit 100, the control unit 100 causes the output unit 130 to generate user feedback via the multi-sensory output devices to simulate the effect or outcome of the user's physical movement (e.g., simulating breathed air coming in or out from the user's nose as shown in the virtual environment) (process operation 510).
Based on the indicators generated by the control unit 100, the control unit 100 can determine the next user movement of a training program for which the user should be prompted (process operation 512).
The control unit 100 causes the output unit 130 to generate a user prompt for the next user movement via the multi-sensory output devices (process operation 514).
The user continues the physical movement cycles of the training program (repeat process starting at operation 502) until an ending condition occurs (e.g., user exit, time, certain score, etc.).

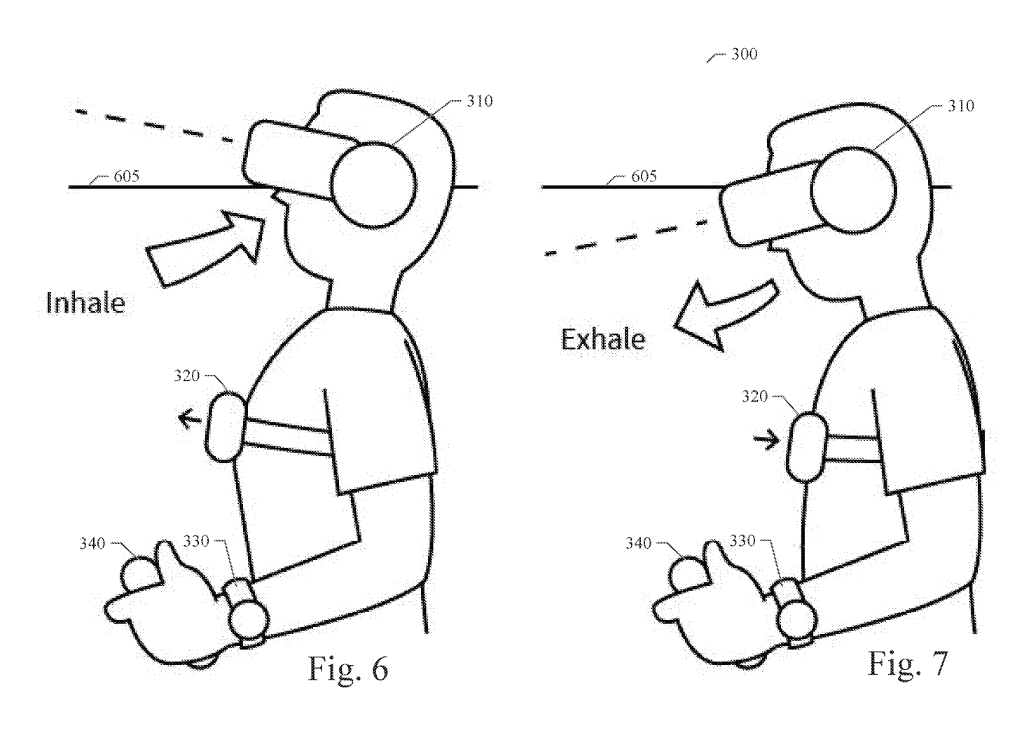

FIGS. 6 and 7 illustrate an example embodiment of a user wearable system 300 wherein sensor inputs are used to estimate and control a user's breathing status and performance. As described above, the headset 310 can include audio and visual output devices of the output unit 130. The headset 310 can also include the breathing sensor of the input unit 110. Various other sensors of the input unit 110, such as position/orientation sensors, heart rate sensors, breathing sensors, and chest size/movement sensors can be installed in a chest mounted device 320. Various other sensors of the input unit 110, such as position/orientation sensors, heart rate sensors, and oxygen sensors can be installed in a wrist-mounted device 330. Vibration or haptic devices of the output unit 130 can be installed in a hand-held device 340. Various other sensors of the input unit 110, such as position/orientation sensors and gesture detection sensors can also be installed in the hand-held device 340. Using the sensor inputs and user outputs of the user wearable system 300 as described above, the user's movements and condition can be monitored and directed. Moreover, the user outputs can be used to direct or control the user's movements to achieve a desired result. In this manner, the example embodiment can be used to monitor the user and to implement a training program to direct or prompt the user to move in a desired manner. For example, as described in more detail below, the user can be trained to breathe or move in a specific and controlled manner by use of the user wearable system 300. Using the various sensor devices of the input unit 110 as described above, the user wearable system 300 can interpret the sensor data from the user and generate various indicators or prompts that define particular user physical movements or conditions. These user movements or conditions can include: a user inhaling event, a user exhaling event, a breath holding event and duration, a user movement and average speed of movement, a level of user movement stability, user heart rate, user oxygen saturation level, stress level, and the like. These user movement and condition indicators can inform and direct the user's progress in accomplishing various portions or milestones of a training program. As a result, the embodiments disclosed herein can implement user breathing and muscle movement training by prompting the user to perform certain actions or movements and then collect the sensor data related to the user actions to determine the user's performance relative to the prompted action. The example embodiments disclosed herein can be used to implement a variety of training programs including: Breath monitoring with a breath sensor, Breath monitoring with posture tracking, Full body muscle training with gesture tracking, and Muscle training with head gaze tracking. Each of these training programs implemented with the user wearable system 300 of an example embodiment are described in more detail below.

Breath Tracking with a Breath Sensor—

FIGS. 6 and 7 illustrate an example embodiment of a user wearable system 300 wherein sensor inputs are used to estimate and control a user's breathing process. If the user wearable system 300 of a particular embodiment is equipped with a breath sensor 312, the user wearable system 300 can use the sensor data directly from the breath sensor 312 to determine the user's current breathing status, such as: inhaling, exhaling, or holding breath. Secondly, the user wearable system 300 can use the sensor data directly from the breath sensor to determine the volume of air being inhaled or exhaled and the duration of each breathing cycle.

Breath Monitoring with Posture Tracking—

Referring again to FIGS. 6 and 7, the user wearable system 300 of a particular embodiment may not be equipped with a breath sensor. In other implementations, the breath sensor may not be supplying accurate or reliable data. In this case, the user wearable system 300 can monitor and track the user's movements or posture to infer or estimate a breathing status and performance. For most people, core muscles always move in certain ways naturally while performing life supporting tasks, such as breathing. For example, during a deep inhaling cycle, most people naturally: (1) raise their head, (2) inflate their chest, (3) straighten their spine, and (4) open up their shoulders. These actions, which are measurable with the sensors of the user wearable system 300 of an example embodiment, are shown in FIG. 6. During a deep exhaling cycle, most people naturally: (1) lower their head, (2) deflate their chest, (3) bow their spine, and (4) relax their shoulders. These actions, which are measurable with the sensors of the user wearable system 300 of an example embodiment, are shown in FIG. 7. In particular, the user's head movement and/or gaze position can be measured relative to a plane 605 corresponding to a natural/neutral gazing position (e.g., a typical line-of-sight or level head position) when the user is in a static position. As shown in FIG. 6, the user's head position typically moves upward above the level plane 605 when the user is inhaling. Conversely, as shown in FIG. 7, the user's head position typically moves downward below the level plane 605 when the user is exhaling. Again, these user actions are measurable with the sensors of the user wearable system 300 of an example embodiment.

Full Body Muscle Training with Gesture Tracking—

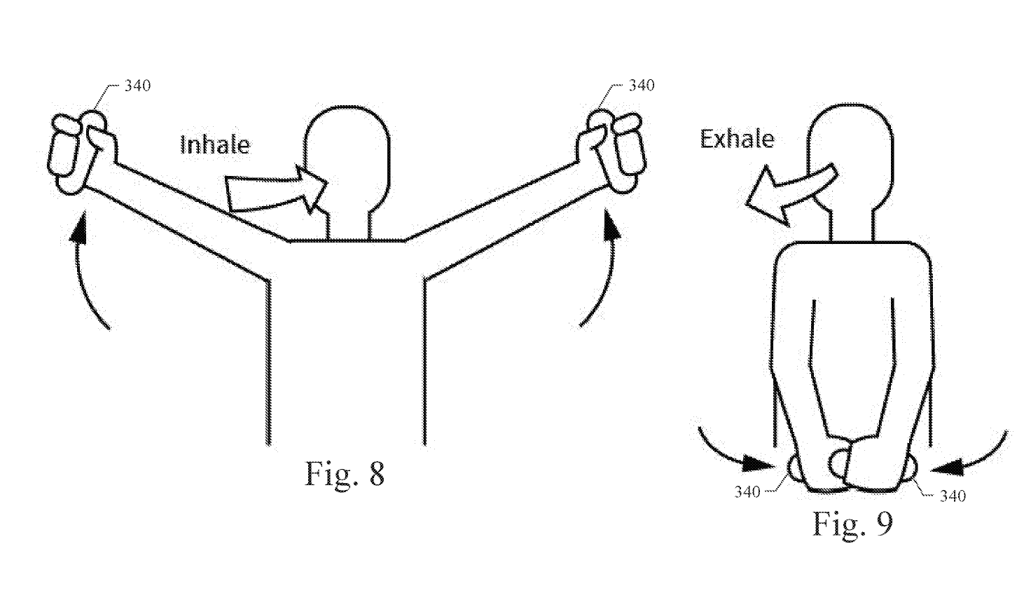

FIGS. 8 and 9 illustrate an example embodiment of a user wearable system 300 wherein sensor inputs are used to monitor and direct user hand movements for full-body muscle training. In an example embodiment, the user wearable system 300 can use sensors of the input unit 110 (e.g., IMU sensors 112 and/or sensors or output devices in the wrist-mounted device 330 or the hand-held device 340), which can be worn or held in the hands. The user can be prompted via displayed indicators or prompts through the headset 310 to perform specific muscle movements. The sensor data received from the hand-held device 340, for example, can enable the processing unit 120 to determine if the user muscle movements were performed as prompted. In this manner, the user wearable system 300 of an example embodiment can extend the tracking coverage of user movements to the entire user's body and enable full body muscle training. For example, an example embodiment can be configured to generate and display user prompts to cause the user to perform movements or postures that are beneficial to the body (e.g., movements or postures based on Yoga, Pilates, core body workouts, etc.). As shown in FIGS. 8 and 9, the example embodiment can also be configured to generate and display user prompts to cause the user to perform particular breathing exercises or movements to improve the user's breathing and/or movement performance. In this manner, the example embodiment can track muscle status with the movement of the user's hands. In other cases, the sensors of the input unit 110 of the user wearable system 300 (e.g., IMU sensors 112 and/or sensors or output devices in the wrist-mounted device 330 or the hand-held device 340) may be installed on or with both hands of the user. The example embodiment can be configured to generate and display user prompts to cause the user to perform particular movements with both hands (e.g., pointing with the hands). This enables the example embodiment to estimate the user's core muscle status and performance with hand position and orientation. Different target positions can be configured to improve the user's core muscle groups. Thus, the example embodiment can guide the user to move their head and hands to complete movements that are beneficial to body.

Muscle Training with Head Gaze Tracking—

In a basic form according to an example embodiment, user muscle training can be monitored and directed by the user wearable system 300 wherein sensor inputs are used to monitor and direct user hand movements. Initially, the user wearable system 300 can estimate the user's core muscle status (e.g., breathing status) using the sensors of the input unit 110 of the user wearable system 300. In many cases, most of the sensors are installed in the headset 310. For implementations where most of the sensors are installed in the headset 310, a process for estimating the user's core muscle status can be based on the user's head orientation (e.g., how the user's head is oriented for gazing).

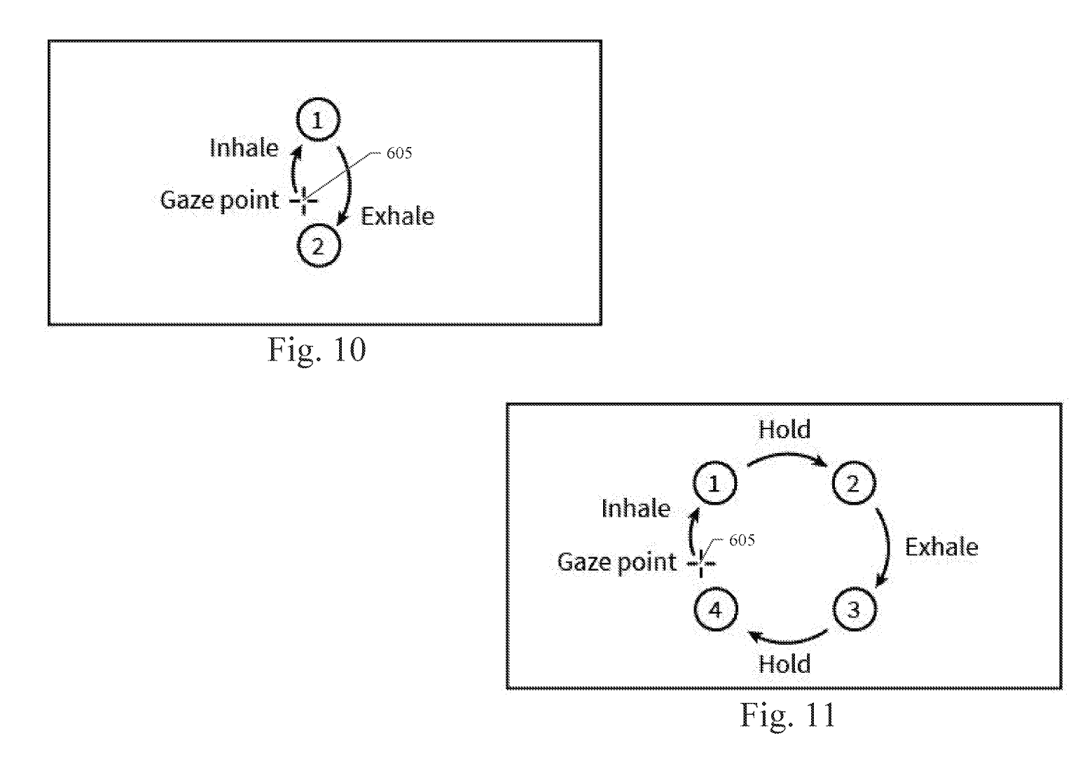

FIG. 10 illustrates an example embodiment of a method for training a user in optimal breathing performance by displaying two pointing targets to focus the user's gaze during inhaling and exhaling breathing cycles. In an implementation of this process using the user wearable system 300 as described herein, the user wearable system 300 can be configured to display two pointing targets via the multi-sensory display device of the output unit 130. The two pointing targets can be used to prompt the user to point (with head or hands) in various directions, one after another. When the user successfully gazes at the first target, the user wearable system 300 can be configured to highlight the next target and so forth. In various training programs, the user wearable system 300 can be configured to position the target above a level plane or a natural/neutral gazing position 605 during deep inhaling cycles and then position the target below the level plane or the natural/neutral gazing position 605 during deep exhaling cycles. By positioning the displayed targets in this manner, the user wearable system 300 can prompt and train the user to move their core muscle group to an ideal posture for optimal breathing performance. Further, the user wearable system 300 can be configured to demonstrate for the user the duration and consistency of their breathing cycles and thus show the user the effectiveness of their breathing performance.

FIG. 11 illustrates an example embodiment of a method for training a user in optimal breathing performance by displaying more than two pointing targets to focus the user's gaze during a square breathing exercise. In an implementation of this process using the user wearable system 300 as described herein, the user wearable system 300 can be configured to display more than two pointing targets via the multi-sensory display device of the output unit 130. The multiple pointing targets can be used to prompt the user to gaze at each of the targets, one after another, while breathing. When the user successfully gazes at the first target while inhaling, the user wearable system 300 can be configured to highlight the next target and so forth. At the second target, the user can be prompted to hold their breath. The user wearable system 300 can be configured to highlight the next target and prompt the user to exhale. The user wearable system 300 can then be configured to highlight the next target and prompt the user to hold their breath again. The process can be repeated to train the user in a square breathing technique. In various training programs, the user wearable system 300 can be configured to position the target above a level plane or a natural/neutral gazing position 605 during deep inhaling and hold cycles and then position the target below the level plane or the natural/neutral gazing position 605 during deep exhaling and hold cycles. By positioning the displayed targets in this manner, the user wearable system 300 can prompt and train the user to move their core muscle group to an ideal posture for optimal square breathing performance. Further, the user wearable system 300 can be configured to demonstrate for the user the duration and consistency of their breathing cycles and thus show the user the effectiveness of their breathing performance.

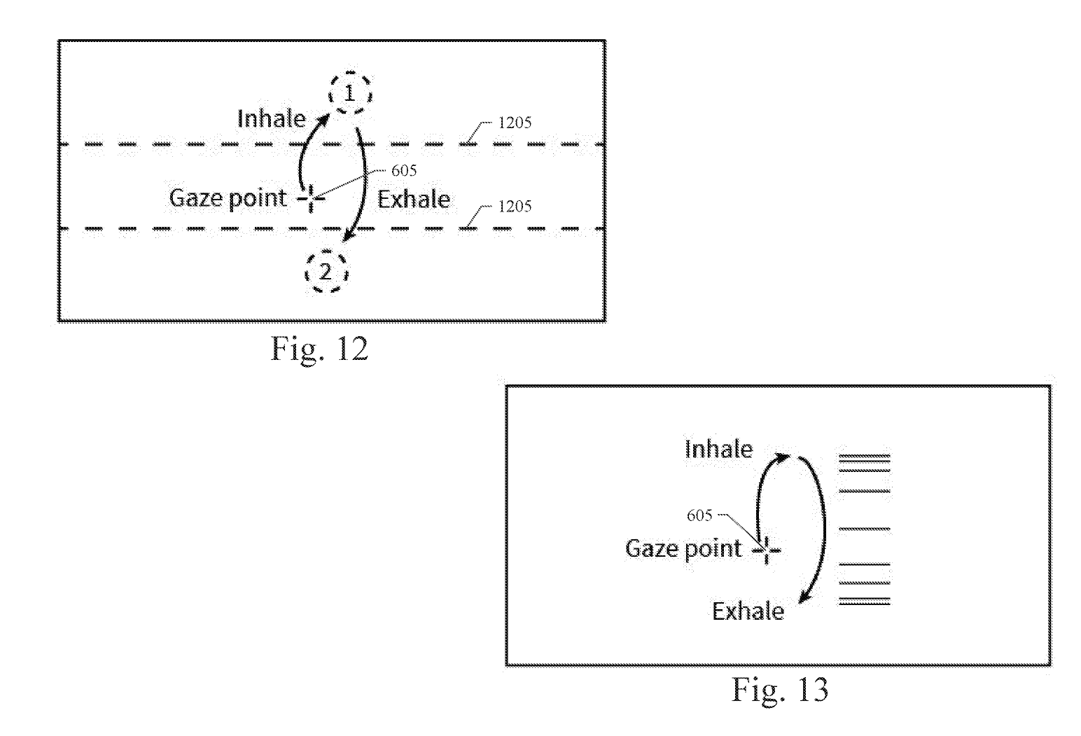

FIG. 12 illustrates an example embodiment of a method for training a user in optimal breathing performance by providing two height planes 1205 to focus the user's gaze at a desired height during inhale and exhale breathing cycles. One issue with breath training using a gazing target is that the user has less freedom to look around. To solve this, an example embodiment can be configured to display two height planes 1205 instead of prompting the user to gaze at certain point targets. In an implementation of this process using the user wearable system 300 as described herein, the user wearable system 300 can be configured to display the two height planes 1205 via the multi-sensory display device of the output unit 130. Typically, one of the two height planes 1205 is displayed above a neutral gaze point 605 (the upper height plane 1205) and the other one of the two height planes 1205 is displayed below the neutral gaze point 605 (the lower height plane 1205). The two height planes 1205 can be used to prompt the user to raise their head above the upper height plane 1205 during an inhale cycle. Similarly, the two height planes 1205 can be used to prompt the user to lower their head below the lower height plane 1205 during an exhale cycle. The user is allowed to move their head laterally as long as their head is above the upper height plane 1205 during an inhale cycle and below the lower height plane 1205 during an exhale cycle. The user wearable system 300 can be configured to highlight the appropriate height plane 1205 for each cycle to prompt the corresponding breathing cycles. By positioning the displayed height planes 1205 in this manner, the user wearable system 300 can prompt and train the user to move their core muscle group to an ideal posture for optimal breathing performance. Further, the user wearable system 300 can be configured to demonstrate for the user the duration and consistency of their breathing cycles and thus show the user the effectiveness of their breathing performance.

FIG. 13 illustrates an example embodiment of a method for training a user in optimal breathing performance by monitoring the height of a user's gaze over time to determine corresponding inhale and exhale breathing cycles. For example, if a current gaze point is higher than a gaze point at a previous point in time, the user wearable system 300 can determine that the user is likely performing an inhalation cycle. Similarly, if a current gaze point is lower than a gaze point at a previous point in time, the user wearable system 300 can determine that the user is likely performing an exhalation cycle. The length of time between a current and previous point in time is configurable. In this manner, the user wearable system 300 can monitor and track a user's breathing patterns. The user wearable system 300 can be configured to demonstrate for the user the duration and consistency of their breathing cycles and thus show the user the effectiveness of their breathing performance.

In another example embodiment, the user wearable system 300 can monitor and track a user's breathing patterns by enabling the user to press a button or activate an input device to mark the beginning and/or ending of each inhale and exhale breathing cycle. In this manner, the user can provide explicit input used to identify and track a user's breathing patterns.

In each of the training methods described herein, multi-sensory feedback is provided for the user to guide the user through each of the movements of the training program. The example embodiment can generate various displayed images, audio prompts, and other signals from the multi-sensory output devices of output unit 130 to create a positive feedback loop to guide the user's muscle movements. For example, the user wearable system 300 of an example embodiment can:
Use the multi-sensory output devices of output unit 130 to present a visual simulated image and corresponding audio of air being inhaled and exhaled from a user's avatar in the virtual environment;
Use the multi-sensory output device of output unit 130 to present the user's influence or effect on the virtual environment. For example, the simulated tree leaves in the virtual environment can be moved when the user inhales and exhales;
Use the multi-sensory output device of output unit 130 to present positive energy or messages when the user performs the prompted movements correctly and vice versa; and
Use the multi-sensory output device of output unit 130 to present stronger influences as the user progresses in performance (e.g., longer duration, more consistent movements, more accurate movements, etc.).

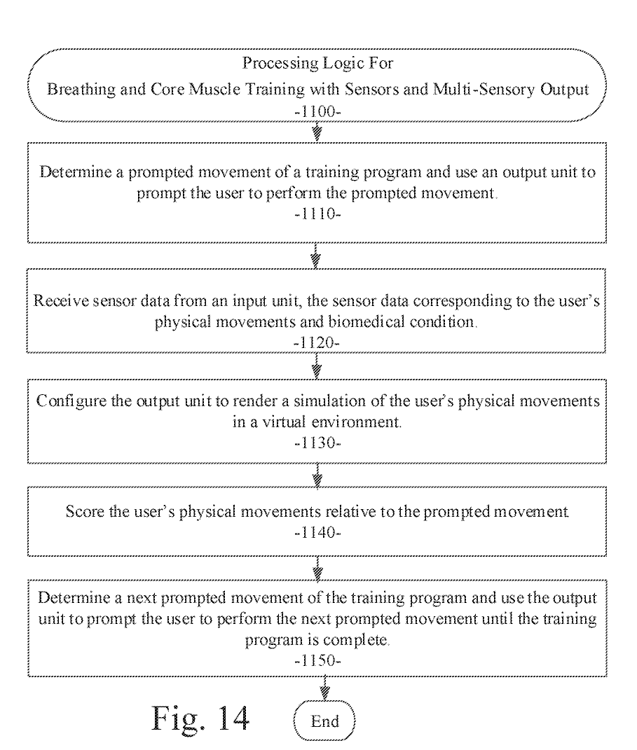

Referring now to FIG. 14, a processing flow diagram illustrates an example embodiment of a method 1100 as described herein. The method 1100 of an example embodiment includes: determining a prompted movement of a training program and using an output unit to prompt the user to perform the prompted movement (processing block 1110); receiving sensor data from an input unit, the sensor data corresponding to the user's physical movements and biomedical condition (processing block 1120); configuring the output unit to render a simulation of the user's physical movements in a virtual environment (processing block 1130); scoring the user's physical movements relative to the prompted movement (processing block 1140); and determining a next prompted movement of the training program and using the output unit to prompt the user to perform the next prompted movement until the training program is complete (processing block 1150).

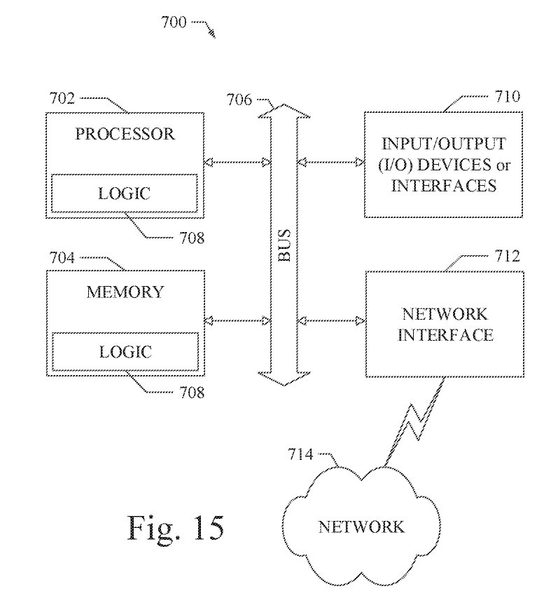

FIG. 15 shows a diagrammatic representation of a machine in the example form of an electronic device, such as a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip [SoC], general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display, an audio jack, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The methods disclosed herein may be implemented as a computer program product, i.e., a computer program tangibly embodied in a non-transitory information carrier, e.g., in a machine-readable storage device, or a tangible non-transitory computer-readable medium, for execution by, or to control the operation of, data processing apparatus, e.g., a programmable processor, a computer, or multiple computers. A computer program may be written in any form of programming language, including compiled or interpreted languages, and it may be deployed in any form, including as a standalone program or as a module, component, subroutine, or other unit suitable for use in a computing environment. A computer program may be deployed to be executed on one computer or on multiple computers at one site or distributed across multiple sites and interconnected by a communication network. A portion or all of the systems disclosed herein may also be implemented by an application-specific integrated circuit (ASIC), a field-programmable gate array (FPGA), a complex programmable logic device (CPLD), a printed circuit board (PCB), a digital signal processor (DSP), a combination of programmable logic components and programmable interconnects, a single central processing unit (CPU) chip, a CPU chip combined on a motherboard, a general purpose computer, or any other combination of devices or modules capable of processing optical image data and generating actions in a virtual world based on the methods disclosed herein. It is understood that the above-described example embodiments are for illustrative purposes only and are not restrictive of the claimed subject matter. Certain parts of the system can be deleted, combined, or rearranged, and additional parts can be added to the system. It will, however, be evident that various modifications and changes may be made without departing from the broader spirit and scope of the claimed subject matter as set forth in the claims that follow. The specification and drawings are accordingly to be regarded as illustrative rather than restrictive. Other embodiments of the claimed subject matter may be apparent to those of ordinary skill in the art from consideration of the specification and practice of the claimed subject matter disclosed herein.

With general reference to notations and nomenclature used herein, the description presented herein may be disclosed in terms of program procedures executed on a computer or a network of computers. These procedural descriptions and representations may be used by those of ordinary skill in the art to convey their work to others of ordinary skill in the art.

A procedure is generally conceived to be a self-consistent sequence of operations performed on electrical, magnetic, or optical signals capable of being stored, transferred, combined, compared, and otherwise manipulated. These signals may be referred to as bits, values, elements, symbols, characters, terms, numbers, or the like. It should be noted, however, that all of these and similar terms are to be associated with the appropriate physical quantities and are merely convenient labels applied to those quantities. Further, the manipulations performed are often referred to in terms such as adding or comparing, which operations may be executed by one or more machines. Useful machines for performing operations of various embodiments may include general-purpose digital computers or similar devices. Various embodiments also relate to apparatus or systems for performing these operations. This apparatus may be specially constructed for a purpose, or it may include a general-purpose computer as selectively activated or reconfigured by a computer program stored in the computer. The procedures presented herein are not inherently related to a particular computer or other apparatus. Various general-purpose machines may be used with programs written in accordance with teachings herein, or it may prove convenient to construct more specialized apparatus to perform methods described herein.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
an input unit including a plurality of sensors;
an output unit including a plurality of multi-sensory output devices; and
a processing unit, in data communication with the input unit and the output unit, the processing unit being configured to:
determine a prompted movement of a training program and use the output unit to prompt the user to perform the prompted movement;
receive sensor data from the input unit, the sensor data corresponding to the user's physical movements and biomedical condition;
configure the output unit to render a simulation of the user's physical movements in a virtual environment;
score the user's physical movements relative to the prompted movement; and
determine a next prompted movement of the training program and use the output unit to prompt the user to perform the next prompted movement until the training program is complete.

2. The system of claim 1 wherein the plurality of sensors includes sensors of a type from the group consisting of: gyroscopes, accelerometers, magnetometers, position and orientation detection trackers, devices for measuring one or more of a variety of environmental conditions, and devices for measuring one or more of a variety of biomedical conditions.

3. The system of claim 1 wherein the plurality of multi-sensory output devices includes devices of a type from the group consisting of: three dimensional (3D) virtual reality (VR) or augmented reality (AR) headset displays, computer displays, tablet displays, mobile device or smartphone displays, projection displays, display panels, monitors, televisions, projectors, video game station/systems, 3D VR/AR headset speakers, earbuds, ear phones, computer speakers, tablet speakers, mobile device or smartphone speakers, external speakers, vibrators, mild electric shock devices, haptic output devices, and motor/servo output devices.

4. The system of claim 1 wherein the processing unit further includes devices of a type from the group consisting of: data processors or central processing units (CPUs), data storage device, a memory, and a wireless data transmitter and receiver (transceiver).

5. The system of claim 1 wherein the training program is of a type from the group consisting of:
breath monitoring with a breath sensor, breath monitoring with posture tracking, full body muscle training with gesture tracking, and muscle training with head gaze tracking.

6. The system of claim 1 wherein scoring the user's physical movements relative to the prompted movement includes measuring the user's head movement relative to a plane corresponding to a neutral gazing position.

7. The system of claim 1 wherein scoring the user's physical movements relative to the prompted movement includes measuring the user's head movement during a breathing cycle.

8. The system of claim 1 wherein scoring the user's physical movements relative to the prompted movement includes measuring the user's body movement to determine if the user's muscle movements were performed as prompted.

9. The system of claim 1 including displaying a plurality of pointing targets to focus the user's gaze during inhaling and exhaling breathing cycles.

10. A method comprising:
providing an input unit including a plurality of sensors;
providing an output unit including a plurality of multi-sensory output devices; and
using a processing unit, in data communication with the input unit and the output unit, for:
determining a prompted movement of a training program and using the output unit to prompt the user to perform the prompted movement;
receiving sensor data from the input unit, the sensor data corresponding to the user's physical movements and biomedical condition;
configuring the output unit to render a simulation of the user's physical movements in a virtual environment;
scoring the user's physical movements relative to the prompted movement; and
determining a next prompted movement of the training program and using the output unit to prompt the user to perform the next prompted movement until the training program is complete.

11. The method of claim 10 wherein the plurality of sensors includes sensors of a type from the group consisting of: gyroscopes, accelerometers, magnetometers, position and orientation detection trackers, devices for measuring one or more of a variety of environmental conditions, and devices for measuring one or more of a variety of biomedical conditions.

12. The method of claim 10 wherein the plurality of multi-sensory output devices includes devices of a type from the group consisting of: three dimensional (3D) virtual reality (VR) or augmented reality (AR) headset displays, computer displays, tablet displays, mobile device or smartphone displays, projection displays, display panels, monitors, televisions, projectors, video game station/systems, 3D VR/AR headset speakers, earbuds, ear phones, computer speakers, tablet speakers, mobile device or smartphone speakers, external speakers, vibrators, mild electric shock devices, haptic output devices, and motor/servo output devices.

13. The method of claim 10 wherein the processing unit further includes devices of a type from the group consisting of: data processors or central processing units (CPUs), data storage device, a memory, and a wireless data transmitter and receiver (transceiver).

14. The method of claim 10 wherein the training program is of a type from the group consisting of: breath monitoring with a breath sensor, breath monitoring with posture tracking, full body muscle training with gesture tracking, and muscle training with head gaze tracking.

15. The method of claim 10 wherein scoring the user's physical movements relative to the prompted movement includes measuring the user's head movement relative to a plane corresponding to a neutral gazing position.

16. The method of claim 10 wherein scoring the user's physical movements relative to the prompted movement includes measuring the user's head movement during a breathing cycle.

17. The method of claim 10 wherein scoring the user's physical movements relative to the prompted movement includes measuring the user's body movement to determine if the user's muscle movements were performed as prompted.

18. The method of claim 10 including displaying a plurality of pointing targets to focus the user's gaze during inhaling and exhaling breathing cycles.

19. A non-transitory machine-useable storage medium embodying instructions which, when executed by a machine, cause the machine to:
determine a prompted movement of a training program and use an output unit to prompt a user to perform the prompted movement;
receive sensor data from an input unit, the sensor data corresponding to the user's physical movements and biomedical condition;
configure the output unit to render a simulation of the user's physical movements in a virtual environment;
score the user's physical movements relative to the prompted movement; and
determine a next prompted movement of the training program and use the output unit to prompt the user to perform the next prompted movement until the training program is complete.

20. The instructions embodied in the machine-useable storage medium of claim 19 wherein the training program is of a type from the group consisting of: breath monitoring with a breath sensor, breath monitoring with posture tracking, full body muscle training with gesture tracking, and muscle training with head gaze tracking.
